(19) United States
(12) Patent Application Publication
(10) Pub. No.: US 2006/0098369 A1
(43) Pub. Date: May 11, 2006

(54) Microcontroller controlled power supply

(76) Inventors: Peter M. Wambsganss, Bexbach (DE); Gareth J. Hackett, Bexbach (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/984,552

(22) Filed: Nov. 8, 2004

(51) Int. Cl. H02H 3/00

(52) U.S. Cl. 361/100

(57) ABSTRACT

A power supply is provided with a microcontroller configured to adjust an output signal from the power supply. A connector that is electronically coupled to the microcontroller includes programming elements, such as resistors or a memory device, that are indicative of a desired output power level. The microcontroller senses one or more characteristics of the programming elements and adjusts the level of power output from the power supply accordingly. The microcontroller may also be configured to monitor connections to the power supply to determine if there are any faults, such as short circuits or bad connections that may damage the power supply or the electronic device powered by the power supply.

### RELATED APPLICATIONS

This application is related to, and hereby incorporates by reference the entire disclosure of each of the following commonly owned U.S. patent applications, each filed on even date herewith: (1) U.S. patent application Ser. No. ______, titled “Temperature Sensor for Power Supply,” (2) U.S. patent application Ser. No. ______, titled “Power Supply Configured to Detect a Power Source,” and (3) U.S. patent application Ser. No. ______, titled “Power Supply Connector.”

### BACKGROUND OF THE INVENTION

1. Field of the Invention

This invention relates to power supplies and, more specifically, to control of power supplies using microprocessors.

2. Description of the Related Art

In order to power many electronic devices, such as household appliances, stereo components, and computing devices, for example, those devices typically include a power supply is typically provided with each electronic device for coupling with an external power source. External power sources may include wall outlets, cigarette lighters in automobiles or other vehicles, and in-seat power delivery systems in aircrafts. Computers, such as notebook, laptop, and tablet computers, for example, are typically powered by power supplies that each provide power at a voltage and current level specific to a particular computer. Thus, if a user owns multiple computers, or other electronic devices, the user typically also owns multiple power supplies, where a separate power supply is used for each computer.

Power supply manufacturers have attempted to alleviate the need for separate power supplies for each electronic device by developing power supplies with multiple voltage and current output levels. In some existing power supplies, the power supplied is determined by programming resistors placed in a plug that is electrically coupled to the power supply, where the plug is shaped to mate with a receptacle portion of the power source. For example, a common approach is to use external programming resistors arranged in a voltage divider configuration, where the voltages from the programming resistors are wired to analog feedback loops that are responsible for the output voltage and current regulation. One disadvantage to this approach is that the resistance of a cable connecting the plug to the power supply may generate a level shift of the reference signals in proportion to the load current delivered to the electronic device, or other load. Thus, in high output current applications, this results in large deviations of the programmed output voltage and current from their nominal values, which may exceed the allowed tolerance specifications of the power supply, may cause the electronic device to operate improperly, and may damage the power supply and/or the electronic device. Accordingly, improved methods and systems for setting a voltage and/or current level of a programmable power supply are desired.

Some currently available AC to DC power supplies allow a user to change an output voltage from the power supply by moving a switch on the power supply. Thus, the voltage may be adjusted while power is transmitted from the power supply to an electronic device, which may potentially damage the electronic device. In addition, the user may need to research the current and voltage requirements for the electronic device in order to properly set the output power level. Thus, improved systems and methods for maintaining an output power level are desired. In addition, improved systems and methods that provide for more user-friendly adjustment of a power supply output signal are desired.

In addition, power supplies typically transform or convert power from any power source without providing any safety mechanisms for disabling the power supply in the event there is a problem with the power supply, including the power cables and connectors. Thus, a power supply that monitors various aspects of the power supply and controls the operation of the power supply according to the monitoring is desired.

### SUMMARY OF THE INVENTION

In one embodiment, a power supply coupled to a power source and configured to deliver power to an electronic device comprises a power module configured to transform an electrical signal received from the power source, thereby generating an output signal, a microcontroller electronically coupled to the power module, a connector electronically coupled to the microcontroller and configured to engagingly mate with the electronic device, and a programming element disposed in the connector, wherein the microcontroller is configured to determine a characteristic of the programming element and adjust one or more aspects of the electrical signal based at least partly upon the determined characteristic.

In another embodiment, a method of controlling an output signal from a power supply comprises setting one or more programming elements in accordance with one or more characteristics of a desired output signal, sensing one or more characteristics of the programming elements, determining the one or more characteristics of the desired output signal based on the sensed one or more characteristic of the programming elements, and configuring the power supply to provide the desired output signal to an electronic device.

In another embodiment, a microcontroller disposed in a power supply, the microcontroller comprises an input configured to receive one or more characteristics of a programming element, a memory storing an algorithm configured to determine one or more characteristics of an output signal based upon the one or more received characteristics, and an output coupled to a power module, wherein the output programs the power module to provide the output signal in accordance with the determined one or more characteristics.

In another embodiment, system for controlling an output signal from a power supply comprises means for setting one or more programming elements in accordance with one or more characteristics of a desired output signal, means for sensing one or more characteristics of the programming elements, means for determining the one or more characteristics of the desired output signal based on the sensed one or more characteristic of the programming elements, and means for configuring the power supply to provide the desired output signal to an electronic device.

In another embodiment, a power control module for selectively controlling an output of a power supply comprises one or more sensors configured to sense a status of one or more electrical connections to the power supply, and a microcontroller electronically coupled to the one or more sensors and configured to receive data signals from the one or more sensors, wherein the microcontroller determines whether the power supply should be deactivated and, in response to determining that the power supply should be deactivated, the microcontroller transmits a signal to a power module of the power supply thereby disabling an output of the power supply.

In another embodiment, a method of controlling the transmission of power from a power supply to an electronic device comprises coupling a power supply to the electronic device, coupling the power supply to a power source, receiving data from one or more sensors including status information of one or more electrical connections coupled to the power supply, determining whether the data received from each of the one or more sensors is within a respective tolerance range, and, in response to determining that the data received from each of the one or more sensors is within their respective tolerance range, transmitting an output power signal to the electronic device.

### BRIEF DESCRIPTION OF THE DRAWINGS

These and other objects and features of the invention will become more apparent from the following description and appended claims taken in conjunction with the following drawings, wherein like reference numbers indicate identical or functionally similar elements.

FIG. 1 is a block diagram of a power supply coupled to an electronic device via a changeable connector.

FIG. 2 is an electrical schematic of an exemplary power supply coupled to a connector and the electronic device.

FIG. 3 is an electrical schematic of an exemplary changeable connector configured to electronically couple with the power supply.

FIG. 4 is an electrical schematic of another exemplary changeable connector configured to electronically couple with the power supply.

### DETAILED DESCRIPTION OF THE PREFERRED EMBODIMENT

The following is a detailed description of embodiments of the invention. However, the invention can be embodied in a multitude of different ways as defined by the claims. The invention is more general than the embodiments that are explicitly described, and accordingly, is not limited by the specific embodiments.

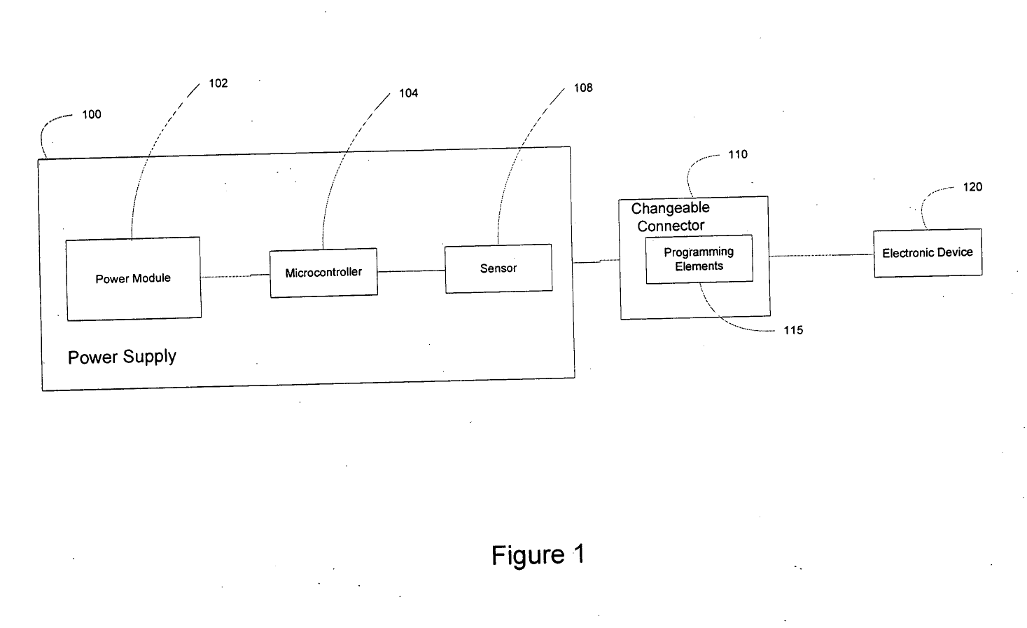

FIG. 1 is a block diagram of a power supply 100 coupled to an electronic device 120 via a changeable connector 110. In the embodiment of FIG. 1, the electronic device 120 is any type of device that may be powered by AC or DC power. The electronic device 120 may include, for example, a household appliance, a stereo component, a computing device, or any other electronic component.

The changeable connector 110 is mechanically shaped to engage with a power delivery portion of the electronic device 120 in delivering power to the electronic device 120. For example, in one embodiment, the changeable connector 110 comprises a plug having one or more positive and negative leads exposed, wherein the plug may be inserted into a socket of the electronic device 120. In one embodiment, the changeable connector 110 is configured to be inserted into a power socket of a portable computing device, such as a notebook computer.

The changeable connector 110 comprises programming elements 115 that may be used by the power supply 100 in adjusting the output voltage of the power supply 100. In one embodiment, the programming elements 115 are sensed by the power supply 100 in order to determine the level of power that is to be delivered to the specific electronic device 120. The programming elements 115 may comprise, for example, an impedance circuit, which may include various components, such as resistors, capacitors, inductors, or any other components known in the art. In one embodiment, the programming elements 115 comprise a programmable data element, such as a memory device, that stores data indicating a desired power level of the power supply. For example, the programming elements 115 may comprise SRAM, DRAM, Masked ROM, PROM, EPROM, EEPROM, Flash, or NVRAM memory components. In another embodiment, the programming elements 115 comprise only resistive elements, where the resistance level of these resistive elements is sensed by the power supply 100 and used in determining a corresponding output power, which typically includes determining both a voltage level and a current level, but may include determining either a voltage or current level when the other level being fixed.

In the embodiment of FIG. 1, the power supply 100 comprises a power module 102, a microcontroller 104, and a sensor 108. In the exemplary embodiment of FIG. 1, the sensor 108 may be any type of sensing device that is capable of determining a level of the programming elements 115, such as a resistance level. For example, if the programming elements 115 comprise resistive elements may comprises an ohmmeter or some other device configured to sense a resistance level. In another embodiment, the programming elements 115 comprise a programmable data element, such as an EPROM, that stores one or more values indicative of a desired output voltage from the power supply 100. In this embodiment, the sensor 108 is capable of determining the values stored in the memory. In one embodiment, the microcontroller 104 comprises the sensor 108. Those of skill in the art will recognize that the features discussed herein with respect to the power supply 100 may be achieved by combining the functionality of multiple components into a single component and/or by separating the functions into further components. For example, in one embodiment the sensor 108 is included in the microcontroller 104.

The microcontroller 104 is coupled to the power module 102 and the sensor 108. The microcontroller 104 receives an output from the sensor 108 indicating one or more sensed level from the programming elements 115. For example, the microcontroller may receive an indications of one or more resistance levels from the sensor 108, such as 37 Ohms, 50 Ohms, 80 Ohms, or any other resistance level. In one embodiment, upon receiving the one or more sensed levels, such as a resistance levels, from the sensor 108, the microcontroller 104 converts the received level to a corresponding digital value and accesses an algorithm configured to translate the one or more received levels to an output voltage and current level for the power supply. The algorithm may include, for example, a current multiplier and a voltage multiplier that are each applied to respectively received resistance levels in order to determine the appropriate voltage and current levels.

In an embodiment using a programmable data element as the programming elements 115, the microcontroller 104 may read one or more values from the data element that indicate a desired voltage and/or current output. The microcontroller 104 may then program the power module 102 to output the voltage and current levels determined by an algorithm or read from the data element. Thus, by adjusting characteristics of the programming elements 115, the output power level of the power supply 100 may be set to any level available. In addition, the granularity of the output voltage and current may be as precise as necessary for the electronic device 120.

In another embodiment, a lookup table is accessed by the microcontroller 104 in order to determine the output voltage and current that corresponds with the data sensed at the programming elements. For example, the lookup table may comprise a table listing in a first column a series of resistance levels, and in a second column a listing of corresponding output voltage levels. Accordingly, the microprocessor 104 may access the lookup table, find the voltage level that corresponds with the sensed level received from the sensor 108, and determine the appropriate output voltage. A similar lookup table may also include a column for determining an output current level based upon a characteristic of the programming elements.

The power module 102 comprises the power delivery components that are configured to transform and/or convert the power received from the power source into power that is transmitted to the electronic device 120. The microcontroller 104 is advantageously coupled to the power module 102 and is configured to control the power level transmitted by the power module 102. In one embodiment, the coupling of the microcontroller 104 to the power module 102 is via one or more amplifiers, diodes, and other electronic components (See FIG. 2, for example). Those of skill in the art will recognize that various components may be used in the power module 102 to transform and/or convert power from a power source. The systems and methods described herein expressly contemplate the use of any suitable components in the power module 102.

In an advantageous embodiment, the microcontroller 104 is configured to control the output voltage and current of the power supply 100 based upon one or more characteristics of the programming elements 115. Accordingly, by selecting a different changeable connector 110, having different programming elements 115, power transmitted by the power supply 100 may also be changed. In one embodiment the power supply may be selectively adjusted to supply a voltage in the range of 3 to 24 volts and a current in the range of 0 to 8 Amps. In other embodiments, the output voltage may be adjustable in one of the ranges: 3-36 volts, 12-48 volts, 12-60 volts, or 1-12 volts, for example. Similarly, the output current may be adjustable in one of the ranges: 0-20 Amps, 0-40 Amps, or 0-80 Amps, for example. In other embodiments, the output voltage and current ranges may be larger or smaller than the above-listed exemplary ranges and may include any voltages and currents.

In one embodiment, the microcontroller 104 is configured to monitor various characteristics of the power supply 100, including input and output cables, the changeable connector 110, the power source to which the power supply 100 is coupled, and the electronic device 120 to which the power supply 100 is coupled. In one embodiment, power management features, such as those utilized in a notebook computer, are utilized by the power supply 100. For example, various types of sensors may be located at different positions on the power supply 100, each with one or more outputs coupled to the microcontroller 104. The microcontroller 104 may monitor the outputs from these sensors and compare the sensed outputs to a tolerance zone, or range of acceptable levels, for each particular sensor or group of sensors. The microcontroller 104 may then adjust characteristics of the power supply according to the inputs from the various sensors.

In one embodiment, as a part of the power management features, the microcontroller may also detect faults in the power supply 100 and adjust characteristics of the power supply 100 accordingly. For example, the faults that may be monitored in a power supply include short circuits, or soft short circuits, in a connecting cable. A short circuit typically occurs when two or more electrical wires contact one another and a soft short circuit typically occurs when two or more electrical wires are not necessarily physically contacting one another, but are in closer proximity than intended by the manufacturer so that an electrical signal on the wires is changed.

In one embodiment, a voltage sensor is placed near each end of a connecting cable, such as the cable connecting the power supply 100 to the electronic device 120 or the cable connecting the power supply 100 to a power source. These voltage sensors may be configured to sense a voltage at a particular position in the cable and transmit an indication of this sensed voltage to the microcontroller 104. The microcontroller 104 may then receive these voltage readings from opposite ends of a power cable and determine whether there is a short circuit (either a complete short circuit or a soft short circuit) in the power cable. For example, if the voltage difference between ends of a power cable is greater than a threshold voltage, the microcontroller 104 may determine that there is a fault in the cable, such as a short circuit. In another embodiment, the voltage difference between ends of a power cable may be analyzed by the microcontroller based on other criteria in order to determine if a fault is present in the power cable. In any situation, the microcontroller 104 is configured to adjust the operation of the power supply 100, such as by disabling the power supply 100 or reducing the power level of the output power signal, based upon the determination of a fault.

Another fault that may be monitored is an undervoltage or undercurrent in a power signal from a power source. For example, if an automobile battery is nearly dead, a voltage from the power source may be less than 2 volts, for example. By placing a voltage sensor in the cable connecting the power source to the power supply, the microcontroller 104 may detect the undervoltage fault. More particularly, the voltage sensor may provide an output to the microcontroller 104 indicating a voltage level. This voltage level may be compared to a threshold voltage level, such as 10V, for example, by the microcontroller 104, which may determine that a fault exists if the voltage is less than the threshold voltage level. A similar procedure may be used to sense a current and recognize an undercurrent fault. In either case, the microcontroller 104 may be configured to disable the power supply 100 or reduce the power level of the output power signal in response to detecting an undervoltage or undercurrent fault.

In one embodiment, the microcontroller 104 is configured to perform one or more fault checks prior to enabling the power module 102 to transmit a power signal to the electronic device 120. For example, the microcontroller 104 may monitor the levels of one or more sensors that indicate faults in the power supply 100, components of the power supply, connections to the power supply 100 (both input and output), and devices coupled to the connections. Those of skill in the art will recognize that various methods and circuitry may be employed to monitor faults in the above-described components. The microcontroller 104 may be configured to communicate with these various circuits in order to monitor faults and adjust one or more characteristics of the power supply 100.

In one embodiment, if a fault is detected, the microcontroller disables the power module 102, thus disabling power output from the power supply 100. Accordingly, when the power supply 100 is first coupled to a power source and an electronic device, the power supply 100 may perform a series of fault checks prior to enabling the power module 102. This same fault monitoring may occur continuously, or periodically, while the power supply 100 is in use. In one embodiment, when a fault is detected after the power module has been activated, the microcontroller 104 is configured to disable output to the electronic device 120. In another embodiment, the microcontroller 104 is configured to perform different actions in response to detection of different faults. For example, if the microcontroller 104 determines that the electronic device has been disconnected, a light, such as an LED may be activated.

FIG. 2 is an electrical schematic of an exemplary power supply 200 coupled to a connector 110 and the electronic device 120. As illustrated in FIG. 2, the power supply 200 comprises a power module 202 and a microcontroller 204. The power supply 200 is electronically coupled to the connector 110 via connection lines 206, which may be combined in a single electrical cable. The microcontroller 204 advantageously receives one or more inputs from the connector 110 indicative of a desired output power that should be delivered to the electronic device 120. The connector 110 comprises one or more programming elements, such as resistors, that are indicative of a desire output power.

In the embodiment of FIG. 2, terminal 2 and 3 of the connector 110 are outputs from programming elements in the connector 110. These terminals are coupled to terminals of the microcontroller 204, or other sensor, in order to determine a desired output power level of the power supply 200. In other embodiments, additional or fewer terminals may be coupled to programming elements. For example, if a connector 110 comprises n programming resistors, n terminals may be coupled to the microcontroller 204 or other sensor. In the embodiment of FIG. 2, terminals 1 and 4 of the connector 110 are coupled to the power supply 200 and receive the power signal transmitted by the power module 202.

In the embodiment of FIG. 2, the microcontroller 204 detects the values of the programming elements in the connector 110 and generates reference signals for current and voltage feedback loops. For example, output terminals 1 and 2 of the microcontroller 204 transmit signals that are used to program the power module 102. More particularly, the output signal on terminal 1 is used as a reference voltage for a voltage feedback loop and the output signal on terminal 2 is used as a reference voltage for a current feedback loop. Thus, these outputs from the microcontroller 204 may be used to control a voltage and current level of the power supply 200.

The values of the programming elements may be measured immediately after the power supply 200 is coupled to a power source or, if the power supply includes an on/off switch, immediately after turning the power supply switch to the on position. In one embodiment, the programming elements are measured prior to enabling the power module 202. Because the programming elements are measured immediately after the power supply 202 is turned on, there is no current flowing between the power supply 200 and the electronic device 120 and, therefore, there are no voltage level shifts due to the current flowing through the connection lines 206. Accordingly, an accurate reading of the programming elements may be obtained and the output voltage and current may be accurately adjusted to the desired level by the microcontroller 202.

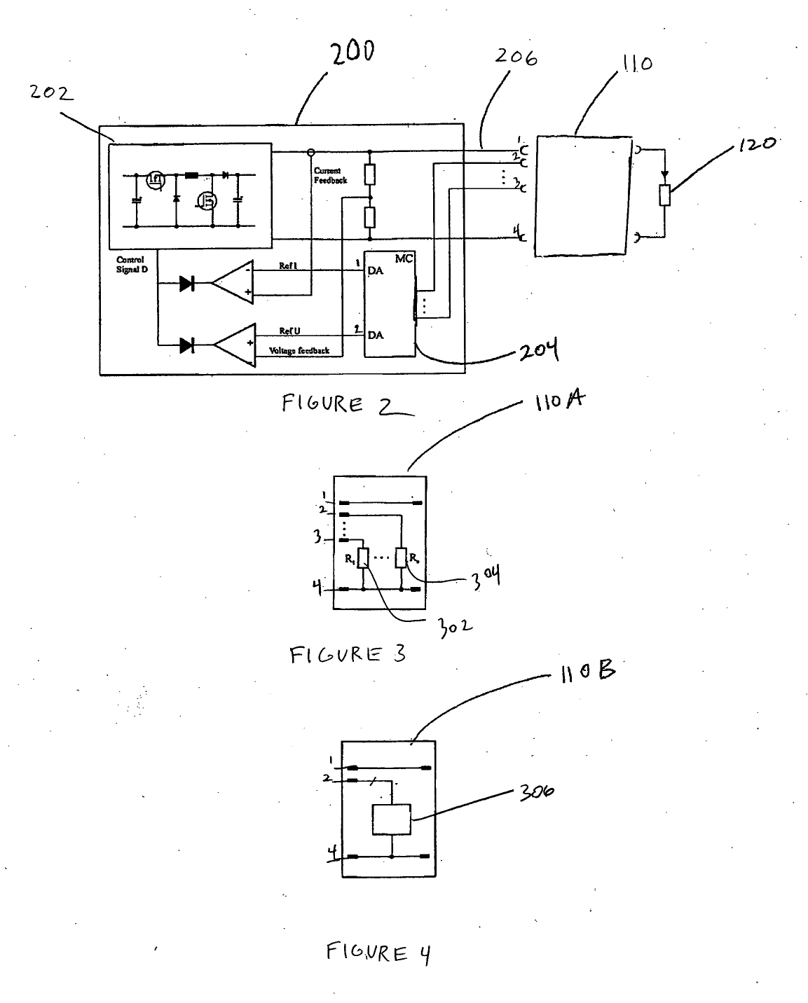

FIG. 3 is an electrical schematic of an exemplary changeable connector 110A configured to electronically couple with the power supply 200. In the embodiment of FIG. 3, the changeable connector 110A includes n resistive elements with values that correspond with a desired output voltage and/or current level. In one embodiment, terminal 4 of the connector 110A is coupled to a first terminal of the resistive elements 302 and 304. In this embodiment, terminal 4 of the connector 110A is coupled to a terminal of the power module 202 that provides a power signal at a predetermined voltage level. Thus, in this embodiment, a power level on terminals 2 and 3 of the connector 110A are dependent on the value of their respective resistive element 302 and 304. Terminals 2 and 3 of the connector 110A may be directly coupled to the microcontroller 202 via the connection lines 206 and the microcontroller 202 may include circuitry capable of sensing a voltage level on the second terminal. Alternatively, a separate sensing device may be used to determine one or more resistance levels of the connector 110A.

In another embodiment, additional programming elements, such as the resistive elements of connector 110A, are included in the connector 110A for programming other aspects of the power supply. For example, a resistive element may be used to indicate a maximum power level of the power supply. Another resistive element may be used to indicate a desired power reduction action to be taken in the event of excessive power being drawn from the power supply, or in response to another fault condition. These desired power reduction actions may include reducing an output current, reducing an output voltage, or a combination of reducing both the output current and voltage. In addition, any other feature of the power supply may be adjusted through the use of additional programming elements in the connector 110A.

FIG. 4 is an electrical schematic of an exemplary changeable connector 110B configured to electronically couple with the power supply 200. In the embodiment of FIG. 4, the changeable connector 110B includes a programmable data element 306, such as an EPROM or other memory device. In this embodiment, one or more terminals of the data element may be coupled to the microcontroller 204 via the connection lines 206. Because the memory device stores digital data, the microcontroller 204 may be configured to directly interface with the data element 306 in reading the stored data. In one embodiment, the stored data indicates a desired power level. In another embodiment, the stored data indicates a desired voltage level and current level. In yet another embodiment, the stored data indicates other features that may be adjusted by the microcontroller 204.

The power supply 100 may communicate with the power source and/or the electronic device in various manners and with various types of information. This communication may be carried out via one or more electrical wires disposed in the connecting lines 206 or in an electrical cable between the power supply 100 and the electronic device 120, for example. In one embodiment, the power supply 100 is configured to communicate information to the electronic device 120 that enables certain functions of the electronic device. For example, certain electronic devices 120 may require that specific types of power supplies are used to power the electronic devices 120. The microcontroller 104 or 204 may be configured to communicate identifying information to the electronic device 120 so that functions of the electronic device 120, such as charging of a battery, are enabled. This identifying information may be stored in a memory device in the power supply, such as in the programming elements 115.

In another embodiment, the programming elements contain information indicative of a temperature threshold to which the power supply is limited. This temperature threshold may included multiple thresholds for various portions of the power supply. In various applications, such as military applications, for example, the temperature requirements may not be as stringent and, thus, by programming the temperature threshold via the programming elements, a power supply used in a military application may be allowed to exceed a temperature threshold for non-military applications. For a detailed description regarding use of temperature sensors in power supplies, refer to commonly owned U.S. patent application Ser. No. ______, titled “Temperature Sensor for Power Supply,” filed on even date herewith, which is hereby incorporated by reference in it's entirety.

In one embodiment, the programming elements include an EPROM that stores identifying information for transmission to an electronic device. In this embodiment, the identifying information may be changed by changing the connector coupled to the power supply. In one embodiment, the EPROM, or other memory device may store identifying information that is configured for communication to various electronic device. In this embodiment, the microcontroller 104 or 204 may be configured to select the proper identifying information, such as in response to an interrogation signal from the electronic device, and communicate the selected identification information to the electronic device. In another embodiment, the microcontroller 104 or 204 may be required to perform a calculation, such as decoding or decrypting a data string received from the electronic device, in order to generate identifying information that may be transmitted to the electronic device. Thus, the microcontroller 104 or 204 may be configured to receive various inputs, manipulate data received from these inputs, and control the operation of the power supply and communicate with components coupled to the power supply in response to the various inputs and/or manipulated data.

Specific parts, shapes, materials, functions and modules have been set forth, herein. However, a skilled technologist will realize that there are many ways to fabricate the system of the present invention, and that there are many parts, components, modules or functions that may be substituted for those listed above. While the above detailed description has shown, described, and pointed out the fundamental novel features of the invention as applied to various embodiments, it will be understood that various omissions, substitutions, and changes in the form and details of the components illustrated may be made by those skilled in the art, without departing from the spirit or essential characteristics of the invention.

What is claimed is:

1. A power supply coupled to a power source and configured to deliver power to an electronic devices the power supply comprising:
a power module configured to transform an electrical signal received from the power source, thereby generating an output signal;
a microcontroller electronically coupled to the power module;
a connector electronically coupled to the microcontroller and configured to engagingly mate with the electronic device; and
a programming element disposed in the connector, wherein the microcontroller is configured to determine a characteristic of the programming element and adjust one or more aspects of the electrical signal based at least partly upon the determined characteristic.

2. The power supply of claim 1, wherein the programming element comprises a resistive component.

3. The power supply of claim 1, wherein the programming element comprises an inductive component.

4. The power supply of claim 1, wherein the programming element comprises a digital data storage component.

5. The power supply of claim 4, wherein the digital data storage component comprises an EPROM.

6. The power supply of claim 1, wherein the microcontroller is configured to adjust at least one of a voltage level and a current level of the electrical signal.

7. The power supply of claim 1, further comprising one or more fault sensors configured to detect faults in the power supply, the one or more fault sensors being electronically coupled to the microcontroller and the microcontroller being configured to disable the power module in response to determining that one of the fault sensors has detected a fault.

8. The power supply of claim 7, wherein faults include short circuits in one or more electrical cables connected to the power supply.

9. A method of controlling an output signal from a power supply, the method comprising:
setting one or more programming elements in accordance with one or more characteristics of a desired output signal;
sensing one or more characteristics of the programming elements;
determining the one or more characteristics of the desired output signal based on the sensed one or more characteristic of the programming elements; and
configuring the power supply to provide the desired output signal to an electronic device.

10. The method of claim 9, wherein the one or more characteristics of the programming elements comprises at least one of: a resistance level, an impedance level, and inductance level, and a state of one or more memory addresses.

11. The method of claim 9, wherein the programming elements comprise a memory device.

12. The method of claim 11, wherein the memory device is selected from the group comprising: SRAM, DRAM, Masked ROM, PROM, EPROM, EEPROM, Flash, and NVRAM memory components.

13. A microcontroller disposed in a power supply, the microcontroller comprising:
an input configured to receive one or more characteristics of a programming element;
a memory storing an algorithm configured to determine one or more characteristics of an output signal based upon the one or more received characteristics; and
an output coupled to a power module, wherein the output programs the power module to provide the output signal in accordance with the determined one or more characteristics.

14. The microcontroller of claim 13, wherein the programming element is disposed in a connector configured to engage a power delivery receptacle of an electronic device.

15. The microcontroller of claim 13, wherein the determined one or more characteristics include a power level and a current level.

16. A system for controlling an output signal from a power supply, the system comprising:
means for setting one or more programming elements in accordance with one or more characteristics of a desired output signal;
means for sensing one or more characteristics of the programming elements;
means for determining the one or more characteristics of the desired output signal based on the sensed one or more characteristic of the programming elements; and
means for configuring the power supply to provide the desired output signal to an electronic device.

17. A power control module for selectively controlling an output of a power supply, the power control module comprising:
one or more sensors configured to sense a status of one or more electrical connections to the power supply; and
a microcontroller electronically coupled to the one or more sensors and configured to receive data signals from the one or more sensors, wherein the microcontroller determines whether the power supply should be deactivated and, in response to determining that the power supply should be deactivated, the microcontroller transmits a signal to a power module of the power supply thereby disabling an output of the power supply.

18. A method of controlling the transmission of power from a power supply to an electronic device, the method comprising:
coupling a power supply to the electronic device;
coupling the power supply to a power source;
receiving data from one or more sensors including status information of one or more electrical connections coupled to the power supply;
determining whether the data received from each of the one or more sensors is within a respective tolerance range; and
in response to determining that the data received from each of the one or more sensors is within their respective tolerance range, transmitting an output power signal to the electronic device.

19. The method of claim 18, further comprising disabling transmission of an output power signal to the electronic device in response to determining that the data received from one or more of the sensors is not within their respective tolerance range.
